(19) United States
(12) Patent Application Publication
(10) Pub. No.: US 2019/0156396 A1
(43) Pub. Date: May 23, 2019

(54) IDENTIFYING PART INTERCHANGES AT ELECTRONIC MARKETPLACES

(71) Applicant: Amazon Technologies, Inc., Seattle, WA (US)

(72) Inventors: Shahrul Azri Ladue, Seattle, WA (US); Heidi Lynn Daigler, Redmond, WA (US); Matthew Paul Harhen, Seattle, WA (US); Gretchen Jane Brown, Seattle, WA (US)

(21) Appl. No.: 16/258,306

(22) Filed: Jan. 25, 2019

Related U.S. Application Data
(63) Continuation of application No. 13/858,400, filed on Apr. 8, 2013, now abandoned.

(51) Int. Cl. G06Q 30/06

(52) U.S. Cl. CPC G06Q 30/0631

(57) ABSTRACT

Electronic marketplaces offer a variety of items to customers over the Internet. Where two or more items are interchangeable with or equivalent to one another, such items may be utilized in the same applications and in the same manner, and marketed and sold together as interchanges or equivalents. Such items may be identified as interchangeable with or equivalent to one another based on a qualitative or quantitative score, which may consider any available information or attributes regarding the items, and may increase or decrease over time as the confidence in a determination of interchangeability or equivalence improves or declines. Moreover, such information or attributes may be identified from any source, such as sellers, vendors or manufacturers of the items, and qualitative or quantitative scores indicative of the accuracy or reliability of such information or attributes may be assigned to such sources, as well.

### CROSS-REFERENCE TO RELATED APPLICATIONS

This application is a continuation of U.S. patent application Ser. No. 13/858,400, filed Apr. 8, 2013, the contents of which are incorporated by reference herein in their entirety.

### BACKGROUND

Complex machines, devices or other pieces of equipment typically include tens, hundreds or even thousands of individual parts. When one of the individual parts breaks, stops operating, or otherwise malfunctions, an owner (or operator) of such equipment has a number of options available for procuring a replacement part. First, the owner may attempt to obtain a replacement for the malfunctioning part directly from the original equipment manufacturer (or “OEM”). Because the original equipment manufacturer of the equipment is familiar with the equipment's contents, dimensions and/or specifications, the owner may buy and install a replacement part obtained directly from the original equipment manufacturer, with a high degree of confidence that the replacement part is suitable for its intended purpose.

Second, the owner may attempt to obtain a replacement for the malfunctioning part, or an equivalent to the malfunctioning part, from sources other than the original equipment manufacturer. For example, where a particular ball bearing in an electric motor must be replaced, the owner may attempt to find either the exact same ball bearing that requires replacement, or a ball bearing having sufficiently identical or equivalent dimensions, specifications or capacities as the ball bearing that requires replacement. If the availability of the malfunctioning part is not subject to any form of monopoly (e.g., if the malfunctioning part is not properly claimed in a valid utility patent, or if the availability of the malfunctioning part is not otherwise limited to a single, exclusive source), the malfunctioning part is considered to be within the public domain, and a replacement for the malfunctioning part, or an equivalent thereto, may be available from any number of sellers, vendors or other manufacturers.

Obtaining either an equivalent to a malfunctioning part from a competitor to an original equipment manufacturer of the malfunctioning part, or a replacement for the malfunctioning part from sources other than the original equipment manufacturer, may be particularly important where the original equipment manufacturer has gone out of business, or has otherwise halted the production of the malfunctioning part. Furthermore, such competitors or other sources of the malfunctioning part, or of equivalent parts, may frequently offer the malfunctioning part, or equivalent parts, at prices that are lower than those that are offered by the original equipment manufacturer.

Electronic marketplaces bring together sellers, vendors and manufacturers of a wide variety of items, using one or more electronic forums or web sites at which customers may review and compare information regarding such items from around the world, in the form of text, images, or audio or video files. In order to make their items available at an electronic marketplace, sellers, vendors or manufacturers of such items must provide an electronic marketplace with information or attributes regarding their respective items, including part numbers, dimensions, weights, colors, capacities, materials or features of such items. Such information or attributes may be used to generate one or more item detail pages for each of the items, which may be displayed to visitors to the marketplace who search or browse for items by providing the electronic marketplace with one or more keywords or search terms, or selecting one or more drop-down menus, buttons or other features. Where an identical item is offered for sale to customers from one or more independent sources (e.g., where multiple sources offer an item having a common part number), the identical item may be presented on a single product detail page, with links or other options for purchasing the identical item from any of the independent sources.

### BRIEF DESCRIPTION OF THE DRAWINGS

FIG. 1 is a block diagram of an illustrative system for identifying interchangeable parts, in accordance with embodiments of the present disclosure.

FIG. 2 is a flow chart of an illustrative process performed by a system for identifying interchangeable parts, in accordance with embodiments of the present disclosure.

FIG. 3 is an illustrative set of data to be considered by a system for identifying interchangeable parts, in accordance with embodiments of the present disclosure.

FIG. 4 is a flow chart of an illustrative process performed by a system for identifying interchangeable parts, in accordance with embodiments of the present disclosure.

FIGS. 5A and 5B are illustrative item detail pages to be displayed by a system for identifying interchangeable parts, in accordance with embodiments of the present disclosure.

FIG. 6 describes an illustrative formula to be utilized by a system for identifying interchangeable parts, in accordance with embodiments of the present disclosure.

### DETAILED DESCRIPTION

As is set forth in greater detail below, the present disclosure is directed to systems and methods for identifying interchangeable or equivalent parts. Specifically, according to some embodiments of the present disclosure, an electronic commerce system (e.g., an electronic marketplace) may receive attributes or information regarding a variety of items from any number of sources, particularly such attributes or information pertaining to uses, applications or functions of the items, and interpret such attributes or information to determine whether any of the items is an “interchange” or an “equivalent” of another item (e.g., whether the part is interchangeable with or equivalent to the other part).

According to one embodiment of the present disclosure, the functional attributes and functional information regarding an item may be utilized to generate one or more metrics or indicators of confidence as to whether the item is interchangeable or equivalent with other items, such as a confidence score or trust score indicative of the interchangeability or equivalence of an item with each of a plurality of other items. The confidence score or trust score may be assigned to or otherwise associated with an item, or with a relationship between an item and another item. Where an electronic commerce system has determined that an item is equivalent to another item based on the confidence score or trust score, the system may display and market such items together in a manner or to an extent consistent with the degree or level of confidence suggested by the confidence score or trust score.

For example, if the value of a confidence score or trust score regarding a relationship between two items is at or near a maximum value (e.g., above a first threshold), thereby indicating that the two items share each or most of the essential functional attributes in common, then the system may elect to market the two items together on a common item detail page. If the value of the confidence score or trust score is substantially high, but less than a maximum value (e.g., below the first threshold but above a second threshold), then the two items may be designated as similar, or as potential equivalents to one another, but marketed independently. If the confidence score or trust score is not sufficiently high (e.g., below the second threshold) then the two items should not be associated with one another, or otherwise suggested as possible equivalents.

The sources of functional attributes or functional information regarding an item that may be utilized to determine whether the item is interchangeable or equivalent with other items (e.g., to calculate a confidence score or trust score associated with relationships between the items) are not limited. For example, a confidence score or a trust score, or a determination of interchangeability or equivalence based thereon, may be calculated according to one or more algorithms or formulas based at least in part on a comparison of the functional attributes of an item (e.g., any lengths, widths or masses of the item, or locations or configurations of the item's features, as they pertain to a use or function of the item) to corresponding attributes of other items. For example, the algorithms or formulas may include one or more weighted factors to reflect the relative significance of certain information or functional attributes in making a determination of interchangeability or equivalence, or may otherwise emphasize such criteria over other criteria in making the determination. Such formulas may make a determination as to the interchangeability or equivalence of one or more items to one or more other items based on or according to any known formulas, algorithms or other statistical means or methods in accordance with the present disclosure.

Additionally, one or more statements or assertions as to the interchangeability or equivalence of items made by a source of an item (e.g., when a seller registers to make an item available at an electronic marketplace, the seller may identify one or more other items with which, in its opinion, the item is equivalent) may also be used to determine whether the item is interchangeable with or equivalent to other items. Similar statements or assertions from the manufacturers of such items may also be interpreted in this manner.

Furthermore, actions taken by customers with regard to the interchangeability or equivalence of items may also be utilized to calculate a confidence score or trust score, or to otherwise determine whether items are interchangeable or equivalent. For example, where a customer searches for a first item, and ultimately purchases a second item having functional attributes or applications that are sufficiently similar or identical to those of the first item, a confidence score or trust score indicative of the interchangeability or equivalence of the second item to the first item with respect to such attributes or applications may be assigned a certain value, or increased in value, accordingly. If, however, the customer ultimately returns the second item and purchases either the first item, or a third item having functional attributes or applications that are sufficiently similar to or identical to those of the first item, the confidence score or trust score indicative of the interchangeability or equivalence of the second item to the first item may be assigned a different value, or decreased in value, accordingly. Additionally, in such a situation, a confidence score or trust score indicative of the interchangeability or equivalence of the third item to the first item may be assigned a certain value, or increased in value, accordingly. As yet another example, where a customer purchases an item identified as an equivalent or an interchange for another item, one or more electronic mail messages or inquiries may be transmitted to the customer to determine whether the customer utilized the item as an equivalent or an interchange for the other item, and whether the use of such an item was successful. Customer feedback provided in this regard may further be utilized to drive a confidence score or trust score in a positive or negative manner.

Where sources provide various ratings or comments regarding the interchangeability or equivalence of an item with other items, including ratings based on number scales or a “star” system, or comments or feedback including text-based discussions of items (e.g., on “blogs” or other web resources of interest to certain trades or groups), such information may also be mined and harvested for use in calculating confidence scores or trust scores, or otherwise determining whether items are interchangeable or equivalent to one another. For example, where sellers, vendors, manufacturers or customers have provided qualitative or quantitative indicia of the interchangeability or equivalence of two or more items (including a rating such as “9.5 out of 10.0” or “four out of five stars,” or statements including nouns, adjectives or adverbs indicative of interchangeability or equivalence such as “Battery A is a perfect fit for Battery B,” “Hack Saw 1 works well in place of Hack Saw 2, and costs less!” or “DO NOT use Fuse X where Fuse Y is required, it WILL NOT WORK!”), such indicia may be interpreted and utilized to assign, increase or decrease a value of a confidence score or trust score for a relationship between two or more items, accordingly.

Furthermore, where sufficient information is identified regarding the interchangeability or equivalence of one item with another item, an electronic commerce system (e.g., an electronic marketplace) could delegate one or more pools of analysts or workers to perform a number of analyses to determine whether, in their opinion, such items were truly interchangeable with or equivalent to one another. In this regard, the system would be able to obtain an unbiased, third-party determination as to the interchangeability or equivalence of the items based on objective sources, and not sellers, manufacturers or vendors of such items, whose primary motivation in identifying one or more items as interchanges or equivalents may be to expand their market share.

According to another embodiment of the present disclosure, a confidence score or trust score may be assigned to each of a number of sources of functional attributes or functional information regarding an item, based on the quality or pertinence of the functional attributes or functional information provided to an electronic commerce system by the respective sources of such attributes or information (e.g., by or on behalf of a specific seller, vendor, manufacturer or customer). For example, where a seller, vendor or manufacturer states that an item is an equivalent of another item, and the item is determined to be an equivalent of the other item, then a confidence score or trust score associated with the specific seller, vendor or manufacturer who identified the items as equivalent may be assigned a certain value, or increased in value, accordingly. Conversely, if the items are ultimately determined not to be equivalent, then the confidence score or trust score associated with the specific seller, vendor or manufacturer who identified the items as equivalent may be assigned a different value, or decreased in value, accordingly.

Likewise, where a customer searches for one item, and purchases an equivalent of that item, the customer may be deemed to be a particularly valuable source of information regarding the interchangeability or equivalence of the items. A confidence score or trust score associated with the customer who identified the items as equivalent may be assigned a certain value, or increased in value, accordingly. If the item purchased by the customer is ultimately determined not to be equivalent to the item that the customer originally sought, however, then the confidence score or trust score associated with the customer may be assigned a different value, or decreased in value, accordingly. Similarly, where a particular network-based forum (e.g., a blog or comment page) is deemed to provide high-quality information regarding the interchangeability or equivalence of items, such as a “do-it-yourself” web page configured to receive comments or feedback from readers, then a confidence score or trust score for that particular forum may be assigned a certain value, or increased in value, accordingly. Network-based forums or other sources of comments or feedback that are deemed to be unreliable sources of information regarding the interchangeability or equivalence of items may be assigned a different value, or decreased in value, accordingly.

Thus, a confidence score or trust score that is calculated or determined for an item, or for a source of information regarding an item (e.g., an individual or entity that asserts that an item is interchangeable or equivalent with another item), may increase, decrease, or remain constant over time.

The interchangeability or equivalence of items may be defined based at least in part on intrinsic attributes and information regarding the items themselves, specifically any uses, applications and/or functions of such items, and not any labels, titles, trademarks or trade dress with which the items are associated. For example, where a customer requires a replacement light bulb, the primary functional attributes that must be considered by the customer when selecting a replacement bulb include the socket into which the replacement bulb must be inserted (e.g., a standard E26 Edison socket) and the wattage level associated with the desired level of light to be provided by the replacement bulb (e.g., sixty watts, or 60 W). Some secondary attributes that may be considered by the customer when selecting a replacement bulb include the type of light source within the bulb (e.g., incandescent, halogen, compact fluorescent), and the color or transparency of the glass surrounding the light source (e.g., clear, white, colored). Therefore, because the customer requires a replacement bulb that would fit into a specific socket, and that would provide the desired level of light, light bulbs that share the primary functional attributes desired by the customer would be deemed equivalent, and light bulbs that fail to include one or all of the primary functional attributes would not, regardless of whether the items shared any secondary attributes in common.

Determining whether an item is an interchange for or an equivalent of another item may be particularly valuable in situations where there customers rarely exhibit, or are unlikely to exhibit, any form of loyalty to a specific brand of item. For example, where a customer requires a box of no. 4 screws having a one-inch (1″) length, the customer is likely to search for and purchase such screws at the lowest available price. Similarly, where a customer requires a replacement air filter for a lawn mower, a bicycle tire pump or a ball peen hammer, items which may typically not carry any form of associated brand loyalty, customers are more likely to base their purchasing decisions primarily on price, and may be more likely to select the air filter, tire pump or hammer that satisfies their individual requirements and is available at the lowest possible cost, regardless of the source that provided the items.

Accordingly, where a seller, vendor, manufacturer or other source of items proposes to offer an item for sale at an electronic marketplace, and provides the electronic marketplace with attributes or other information regarding the item, the electronic marketplace may make one or more qualitative or quantitative determinations as to the interchangeability or equivalence of the proposed item to one or more other items. Determinations of interchangeability or equivalence may be made on any basis, and may be modified to reflect attributes or information regarding the items that may be obtained in the future, from any source. Furthermore, once a degree of interchangeability or equivalence has been determined regarding an item with respect to one or more other items, the item may be marketed with or alongside the other items based on the degree of interchangeability or equivalence thereof. Moreover, the extent to which items are marketed together as interchanges or equivalents may vary depending on the degree of interchangeability or equivalence between them.

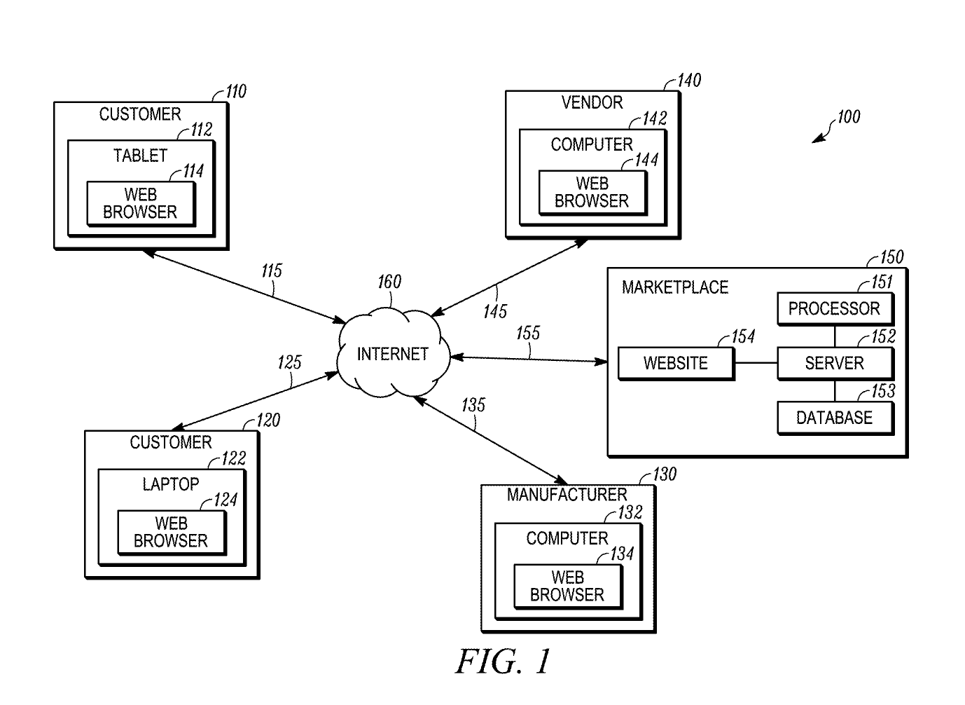

Referring to FIG. 1, the various components of one embodiment of a method and system for identifying interchangeable parts, in accordance with embodiments of the present disclosure, are shown. The system 100 includes a plurality of customers 110, 120 (or users, consumers, clients, shoppers or buyers), a manufacturer 130, a vendor 140 and an electronic marketplace (or supplier, retailer, seller, reseller or distributor) 150.

The customers 110, 120 may be any entities or individuals that wish to download, purchase, rent, lease, borrow or otherwise obtain items (which may include goods, products, services or information of any type or form) from the marketplace 150. The customers 110, 120 may utilize one or more computing devices, such as a tablet computer 112, a laptop computer 122 or any other like machine that may operate or access one or more software applications, such as a web browser 114, 124. The tablet computer 112, the laptop computer 122, or the other like machines utilized by the customers 110, 120 may be connected to or otherwise communicate with manufacturer 130, the vendor 140, the marketplace 150 or one another through a communications network 160, such as the Internet, as indicated by lines 115, 125 by sending and receiving digital data over the network 160.

The manufacturer 130 and the vendor 140 may be any individuals or entities that manufacture or sell, respectively, items (including goods, products, services or information of any type or form) to be made available at the marketplace 150 to customers, including but not limited to customers 110, 120.

The manufacturer 130 and the vendor 140 may utilize one or more computing devices, such as a manufacturer computer 132 or a vendor computer 142 or any other like machine which may operate or access one or more software applications, such as a web browser 134, 144. The manufacturer computer 132 or the vendor computer 142 utilized by the marketplace 130 or the vendor 140, respectively, may be connected to or otherwise communicate with the customers 110, 120 the marketplace 150 or one another through the communications network 160 as indicated by lines 135, 145 by sending and receiving digital data over the network 160.

The web browsers 114, 124, 134, 144 operating on the tablet computer 112, the laptop computer 122, the marketplace computer 132 or the vendor computer 142, respectively, provide one or more features or user interfaces that permit the customers 110, 120, the marketplace 130 and the vendor 140 to view and access electronic content, such as the content provided at one or more web sites, including but not limited to the marketplace web site 154. Also, those of skill in the pertinent art will recognize that the customers 110, 120, the marketplace 130 and the vendor 140 may use a keyboard, keypad, mouse, stylus, touch screen, or other device (not shown) or method for interacting with the tablet computer 112 or the laptop computer 122, the marketplace computer 132 or the vendor computer 142 and/or the web browsers 114, 124, 134, 144 operating thereon, or to “select” an item, link, node, hub or any other aspect of the present disclosure.

The operator of the marketplace 150 may be any entity that sells or otherwise makes items available for download, purchase, rent, lease or borrowing by customers, such as the customers 110, 120. Additionally, the operator of the marketplace 150 itself may also be a manufacturer or vendor, such as the manufacturer 130 or the vendor 140.

The marketplace 150 may include or operate one or more physical computer processors 151, servers 152 and/or databases 153, and maintain a marketplace web site 154 which may be implemented using one or more of the servers 152. Additionally, the marketplace 150 may feature software applications and/or hardware components for analyzing data received from customers, such as customers 110, 120, the manufacturer 130 and/or the vendor 140 including data regarding the interchangeability or equivalence of items, in numerical or text-based forms. The marketplace 150, the processors 151, the servers 152 and/or the databases 153 may be connected to or otherwise communicate with the customers 110, 120, the manufacturer 130 and the vendor 140, as indicated by line 155, by sending and receiving digital data over the network 160.

The computers, servers, devices and the like described herein have the necessary electronics, software, memory, storage, databases, firmware, logic/state machines, microprocessors, communication links, displays or other visual or audio user interfaces, printing devices, and any other input/output interfaces to perform the functions described herein and/or achieve the results described herein.

Except where otherwise explicitly or implicitly indicated herein, the terms “user,” “customer,” “consumer,” or like terms, may refer to any entity or individual that wishes to download, purchase, rent, lease, borrow, or otherwise obtain items or media from a marketplace and/or a media service, as well as the associated computer systems operated or controlled by a customer, a consumer or a user, respectively.

Except where otherwise explicitly or implicitly indicated herein, the term “manufacturer” or “vendor,” or like terms, may refer to any entity or individual that manufacturers or sells items to be made available for download, purchase, rent, lease or borrowing by customers from an electronic marketplace. Except where otherwise explicitly or implicitly indicated herein, the term “marketplace,” or like terms, may refer to any entity or individual that sells or otherwise makes items available for download, purchase, rent, lease or borrowing using one or more computer systems, as well as the associated computer systems operated or controlled by such a marketplace.

Thus, process steps described as being performed by a “user,” a “customer” or a “consumer,” a “manufacturer,” a “vendor” or a “marketplace” may be automated steps performed by their respective computer systems or devices, or implemented within software modules (or computer programs) executed by one or more computer systems or devices. Specially designed hardware could, alternatively, be used to perform certain operations.

The customers 110, 120 may use any software, web-enabled or Internet applications operating on a computing device 112, 122, such as the web browsers 114, 124 or any other client-server applications or features including electronic mail (or E-mail), short or multimedia messaging service (SMS or MMS) text messages, or other messaging techniques to communicate with (or connect to) the marketplace processors 151, servers 152, databases 153 and/or web sites 154, through the communications network 160. In addition, while the customers 110, 120 are shown in FIG. 1 as using a tablet computer 112 and a laptop computer 122, respectively, the computing devices utilized by users in accordance with the present disclosure may be any of a number of computer-related machines or computing devices that are capable of communicating over the network 160, including but not limited to set-top boxes, personal digital assistants, mobile telephones, digital media players, web pads, desktop computers, televisions, automobile entertainment systems, appliances, electronic book readers, and the like, or processors therefor. The protocols and components for providing communication between the computing devices 112, 122, 132, 142 and/or the web browsers 114, 124, 134, 144, and the marketplace server 152 and/or web site 154, are well known to those skilled in the art of computer communications and thus, need not be described in more detail herein.

The data and/or computer executable instructions, programs, firmware, software and the like (also referred to herein as “computer executable” components) described herein may be stored on a computer-readable medium that is within or accessible by the tablet computer 112, the laptop computer 122, the manufacturer computer 132, the vendor computer 142 and/or the marketplace servers 152, and having sequences of instructions which, when executed by a processor (such as a central processing unit, or CPU), cause the processor to perform all or a portion of the functions and/or methods described herein. Such computer executable instructions, programs, software and the like may be loaded into the memory of the tablet computer 112, the laptop computer 122, the manufacturer computer 132, the vendor computer 142 and/or the marketplace servers 152 using a drive mechanism associated with the computer-readable medium, such as a floppy drive, CD-ROM drive, DVD-ROM drive, network interface, or the like, or via external connections.

Some embodiments of the systems and methods of the present disclosure may also be provided as a computer executable program product including a non-transitory machine-readable storage medium having stored thereon instructions (in compressed or uncompressed form) that may be used to program a computer (or other electronic device) to perform processes or methods described herein. The machine-readable storage medium may include, but is not limited to, hard drives, floppy diskettes, optical disks, CD-ROMs, DVDs, read-only memories (ROMs), random access memories (RAMs), erasable programmable read only memories (EPROMs), electrically erasable programmable read only memories (EEPROMs), flash memory, magnetic or optical cards, solid-state memory devices, or other types of media/machine-readable medium that may be suitable for storing electronic instructions.

The present disclosure is generally directed to systems and methods for identifying interchangeable or equivalent items to customers. For the purposes of illustration, some of the systems and methods disclosed herein may be referenced primarily in the context of the purchases of industrial parts by customers at an electronic marketplace, such as the customers 110, 120 and electronic marketplace 150 shown in FIG. 1. As will be recognized by those of skill in the art, however, the systems and methods disclosed herein may also be used in many other situations or with many other components.

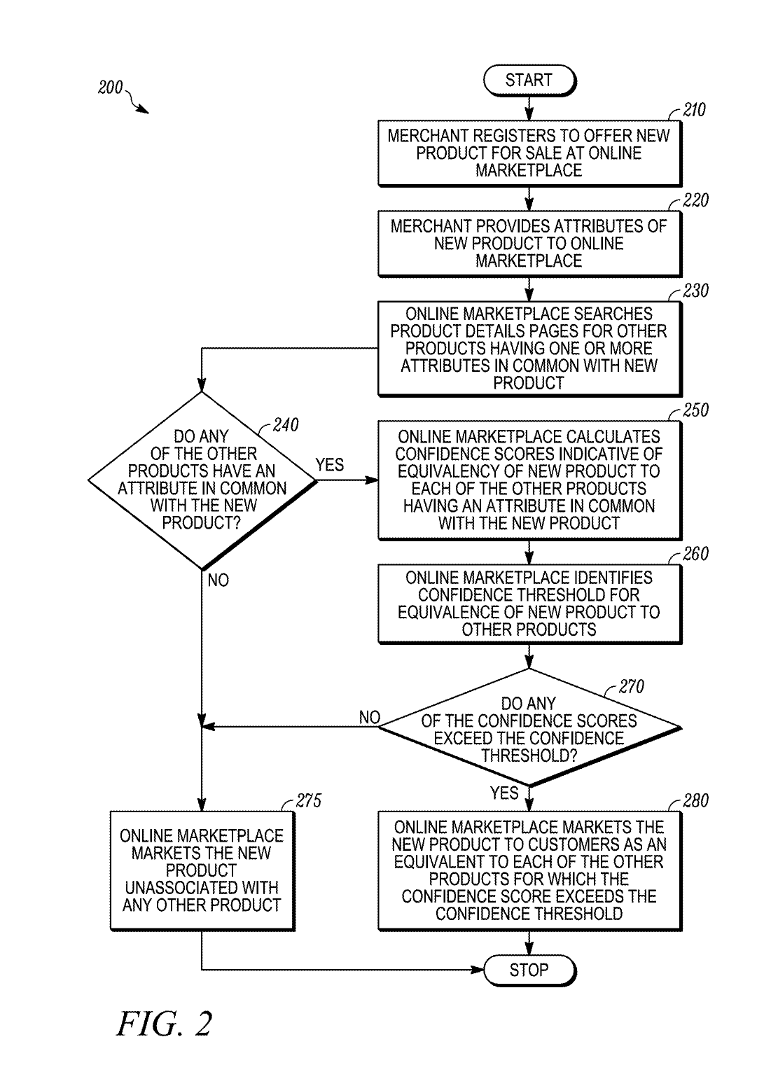

Referring to FIG. 2, a flow chart 200 of an illustrative process performed by a system for identifying interchangeable parts in accordance with embodiments of the present disclosure is shown. At box 210, the merchant registers to offer a new item for sale at the electronic marketplace, and at box 220, the merchant provides the electronic marketplace with attributes of the new item. The registration may identify the merchant and the new item, and include any other relevant information regarding either the merchant or the item, including any dimensions, specifications, capacities or other attributes of the item, or possible uses, functions or applications of the item.

At box 230, the electronic marketplace searches one or more item detail pages for other items having one or more attributes in common with the new item. For example, where the merchant is registering to sell lantern batteries at the electronic marketplace, the merchant may identify the voltage levels of the batteries (e.g., twelve volts, or 12 V), the shape or form of the terminals (e.g., spring or screw terminals) and the materials within the battery (e.g., alkaline or zinc-carbon), and the electronic marketplace may search one or more item detail pages for items sharing one or more attributes in common with the lantern batteries identified by the merchant. If no other items having attributes in common with the lantern battery are identified at box 240, then the process advances to box 275, where the electronic marketplace markets the new item without any association with any other item, and the process ends.

If any other existing items are identified as having one or more attributes in common with the new item, then the process advances to box 250, where the electronic marketplace calculates confidence scores indicative of the equivalency of the new item to each of the existing items sharing an attribute in common with the new item. For example, the electronic marketplace may calculate a confidence score or trust score according to one or more formulas or algorithms, based at least in part on any of the attributes of the new item and/or the other items, to determine whether the new item and any of the other items are equivalent to one another. The selected attributes that may be provided for consideration in such a formula or algorithm may relate to any aspect or relationship of the items, as well as aspects of their intended uses, applications or functions (e.g., for a car battery, not only a size and a shape, but also a voltage level or location of the respective terminals thereof).

At box 260, the electronic marketplace identifies a confidence threshold for determining whether a new item is equivalent to an existing item, which may be defined based on any factor (e.g., safety or other concerns) regarding the respective items. For example, where an existing item is a piston in an automobile engine, a confidence threshold for identifying equivalents may be very high, based on the high operating speeds of the engine and the close tolerances between the piston and the motor head, camshafts and other components of the engine block. If the wrong piston is incorporated into an automobile engine, the potential for damaging the engine, or nearby personnel, may be very high. As another example, where the item is an external Universal Serial Bus (USB) flash drive, the confidence factor may be very low, because the dimensions of a USB port and corresponding plug are standard, and because the risk of damage through the use of an improper USB flash drive is low.

At box 270, the system determines whether any of the confidence scores exceed the confidence threshold. If none of the scores exceeds the threshold, then the process advances to box 275, where the electronic marketplace markets the new item without any association with any other item, and the process ends. If any of the confidence scores exceeds the confidence threshold, then the process advances to box 280, where the electronic marketplace markets the new item as an equivalent to each of the existing items for which the confidence score exceeds the confidence threshold, and the process ends.

Accordingly, the systems and methods of the present disclosure may be utilized to determine whether an item to be made available at an electronic marketplace is equivalent to any of the items that are presently available at the electronic marketplace using one or more quantitative and qualitative means, and to market the item for sale with such equivalent items.

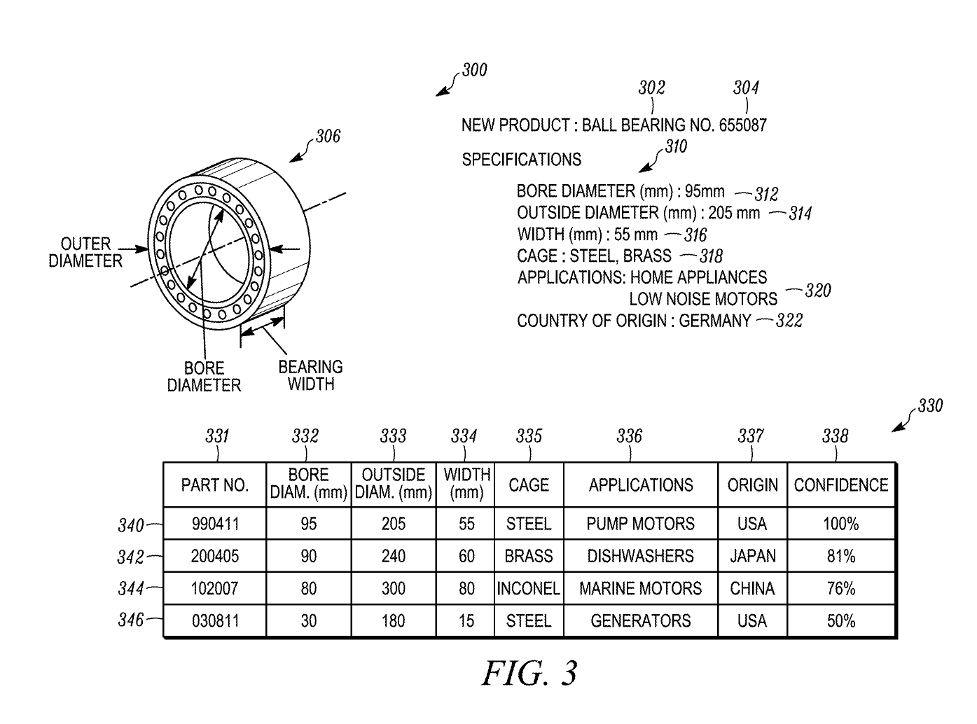

As is discussed above, determinations of interchangeability or equivalence may be made based on any attributes of items, including but not limited to one or more dimensions, masses, materials or intended uses, applications or functions of the items. Referring to FIG. 3, a set of data 300 to be considered by a system for identifying interchangeable parts in accordance with embodiments of the present disclosure is shown. The set of data 300 relates to an item 302 (e.g., a ball bearing) that a seller has requested to make available at an electronic marketplace, including a part number 304 of the item 302 and an image of the item 302.

The set of data 300 also includes specifications 310 of the item 302, including a bore diameter 312, an outside diameter 314, a width 316, a cage material 318, applications 320 of the item 302 and a country 322 of origin of the item 302. The set of data 300 further includes a table 330 of attributes of existing items 340, 342, 344, 346 to the item 302, sorted by columns including part numbers 331, bore diameters 332, outside diameters 333, widths 334, cage materials 335, applications 336, countries of origin 337 and confidence scores 338 calculated with regard to a relationship between the item 302 and each of the existing items 340, 342, 344, 346.

As is shown in FIG. 3, the existing item 340 and the item 302 have identical bore diameters, outside diameters and widths. Additionally, the existing item 340 and the item 302 have similar cage materials in that the cage of the item 302 is made of steel and brass, while the cage of the existing item 340 is made of steel. The existing item 340 and the item also have similar applications, in that the item 302 is intended for use in home appliances and in low noise motors, while the existing item 340 is intended for use in pump motors, which may include household machines or low-noise applications.

Accordingly, based on the identical dimensions, the nearly identical materials and the similar uses, the existing item 340 has the highest confidence score 338 of any of the existing items 340, 342, 344, 346, and the item 302 may be deemed an equivalent to existing item 340. Therefore, based on the confidence score 338, an electronic marketplace may reasonably offer the item 302 to customers as an alternative to the existing item 340.

The various existing items 342, 344, 346 each have confidence scores 338 that are less than the confidence score 338 of the existing item 340. Therefore, an electronic marketplace may not reasonably offer the item 302 to customers as alternatives to the existing items 342, 344, 346, based on the one or more intrinsic differences between the item 302 and each of the existing items 342, 344, 346. For example, the existing item 342 has a slightly smaller bore diameter, and a slightly larger outside diameter and width, than the item 302. The existing item 344 has a substantially smaller bore diameter but a larger outside diameter and width than the item 302, while the existing item 346 has a significantly smaller bore diameter, outside diameter and width than the item 302. Depending on the confidence thresholds associated with the item 302 and/or the applications or uses in which the item 302 or the existing items 342, 344, 346 are operated, however, the item 302 may also be offered as alternatives to the existing items 342, 344, 346 if the respective confidence scores 338 exceed the respective confidence thresholds.

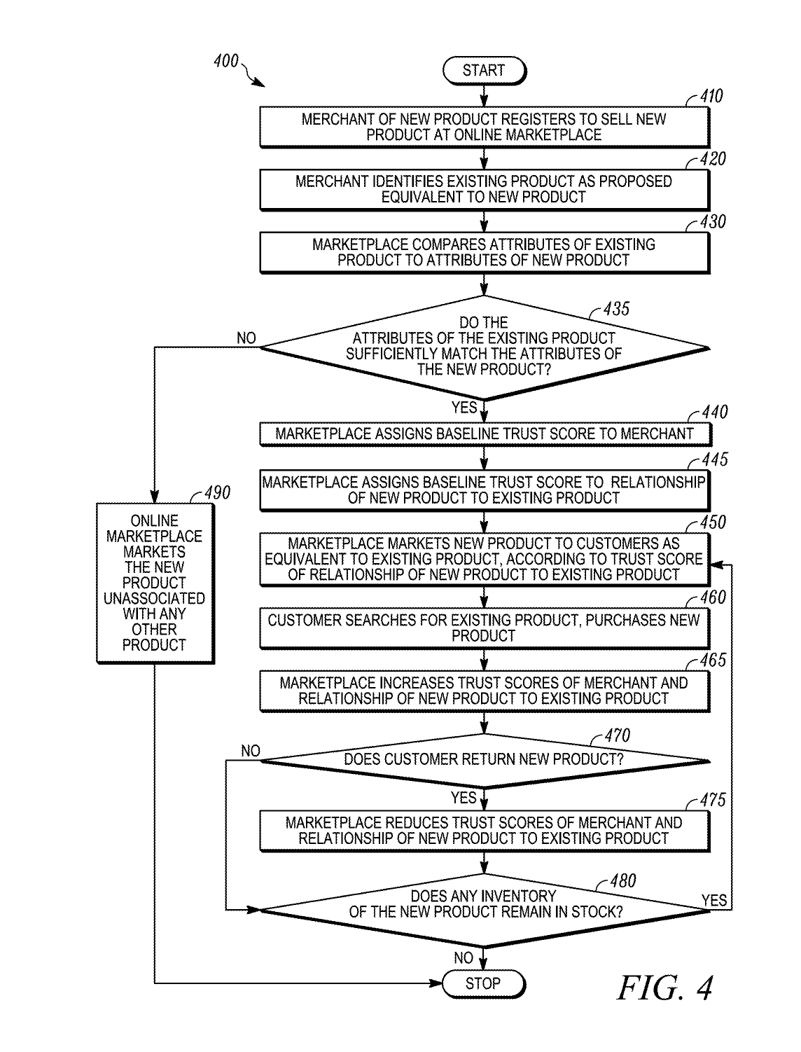

As is discussed above, a confidence score or a trust score may be calculated as a measure of an item's interchangeability or equivalence to another item, and either increased or decreased if the item is confirmed as equivalent or not equivalent to the other item accordingly. Similarly, a confidence score or a trust score may be calculated for a seller, vendor, manufacturer, customer or other individual or entity who asserts that an item is interchangeable with or equivalent to another item, and either increased or decreased if the item is confirmed as equivalent or not equivalent to the other item accordingly. Referring to FIG. 4, a flow chart 400 of an illustrative process performed by a system for identifying interchangeable parts in accordance with embodiments of the present disclosure is shown.

At box 410, a merchant of a new item registers to sell the new item at an electronic marketplace, and at box 420, identifies an existing item as a proposed equivalent to the new item. For example, the merchant may register to sell a new automobile battery, and may identify automobile batteries with which the new automobile battery is equivalent. At box 430, the marketplace may compare the attributes of the existing item identified by the merchant to the attributes of the new item. At box 435, if the attributes do not sufficiently match the attributes of the new item, then the process advances to box 490, where the electronic marketplace markets the new item without any association with any other item, and the process ends.

If the attributes of the existing item sufficiently match the attributes of the new item, then the process advances to box 440, where the marketplace assigns a baseline trust score to a merchant, and to box 445, where the marketplace assigns a baseline trust score to a relationship between the new item and the existing item. For example, based on an assertion of a merchant of an item that the item is equivalent to another item, the system may define a certain degree of confidence that the item is equivalent to the other item, and a certain degree of confidence that the merchant has provided a reliable recommendation, based on the similarity in attributes between the item and the other item.

At box 450, the marketplace markets the new item to customers as an equivalent to the existing item, according to the trust score of the new item. For example, if the trust score for the equivalence of the new item to the existing item is at a high level (e.g., such as the confidence score 338 of the item 302 with respect to the existing item 340 shown in FIG. 3), then the new item may be expressly marketed as nearly identical to the existing item (e.g., on the same item detail page as the existing item). If the trust score is at a medium level, the new item may be displayed in search results corresponding to the existing item, or shown as an available option when a customer views an item detail page for the existing item. If the trust score is at a low level, then the new item should not be associated with the existing item in any way.

At box 460, the customer searches for the existing item and purchases the new item. When such a purchase is made, the customer is effectively communicating his or her conclusion that the new item and the existing item are equivalent to one another. Because the customer's purchase is an implicit endorsement of both the assertions of equivalence made by the merchant at box 420, and the understanding that the new item and the existing item are, in fact, equivalent, the process advances to box 465, where the trust scores of both the merchant and the equivalence the new item and the existing item are increased accordingly.

At box 470, the marketplace determines whether the customer has returned the new item that was purchased at box 460. If the item is returned, then the process advances to box 475, where the marketplace reduces the trust scores of the merchant and the new item, respectively. Just as the customer's purchase at box 460 may be interpreted as an implicit endorsement of the equivalence of the new item and the existing item, a return of the item by the customer may be interpreted as an implicit disapproval of the assertions of equivalence made by the merchant at box 420, and of any understanding or inference that the new item and the existing item are equivalent.

If the customer does not return the new item at box 470, or after the marketplace reduces the trust scores of the merchant and the equivalence of the new item and the existing item at box 475, the process advances to box 480, where the system determines whether any inventory of the new item remains in stock. If the item is out of stock, the process ends. If the item remains in stock, then the process returns to box 450, where the marketplace markets the new item to customers as an equivalent to the existing item according to the trust score of the new item, which may have been increased at box 465 or decreased at box 475. For example, if the trust score of the equivalence of the new item to the existing item has increased, then the marketplace may elect to market the new item as an equivalent to the existing item more aggressively, e.g., by offering the new item on the same item detail page as the existing item, by displaying the new item in search results corresponding to the existing item, or by showing the new item as an available option when a customer views an item detail page for the existing item. Conversely, if the trust score of the equivalence of the new item to the existing item has decreased, then the marketplace may elect to deemphasize any association between the new item and the existing item.

Accordingly, the systems and methods of the present disclosure may be utilized to define a qualitative or quantitative metric that may be assigned to not only an item, e.g., as a measure of that item's equivalence to another item, but also to a source of information regarding an item, e.g., as a measure of a seller's, a vendor's, a manufacturer's or a customer's accuracy or judgment in identifying two or more items as equivalent to one another.

As is discussed above, where an electronic marketplace determines that an item is equivalent to another item based on a confidence score or trust score, the marketplace may display and market the items together in a manner or to an extent that is consistent with the value of the confidence score or trust score. Where a confidence score or trust score is high, the items may be offered to customers together as equivalents, such as on the same item detail page. Where a confidence score has a medium value, the items may be generally associated with each other, and may appear together in common search results for the either of the items, and one item may be shown as an available option when a customer views an item detail page for the other item. Where a confidence score or trust score is low, then the new item should not be associated with the existing item in any way.

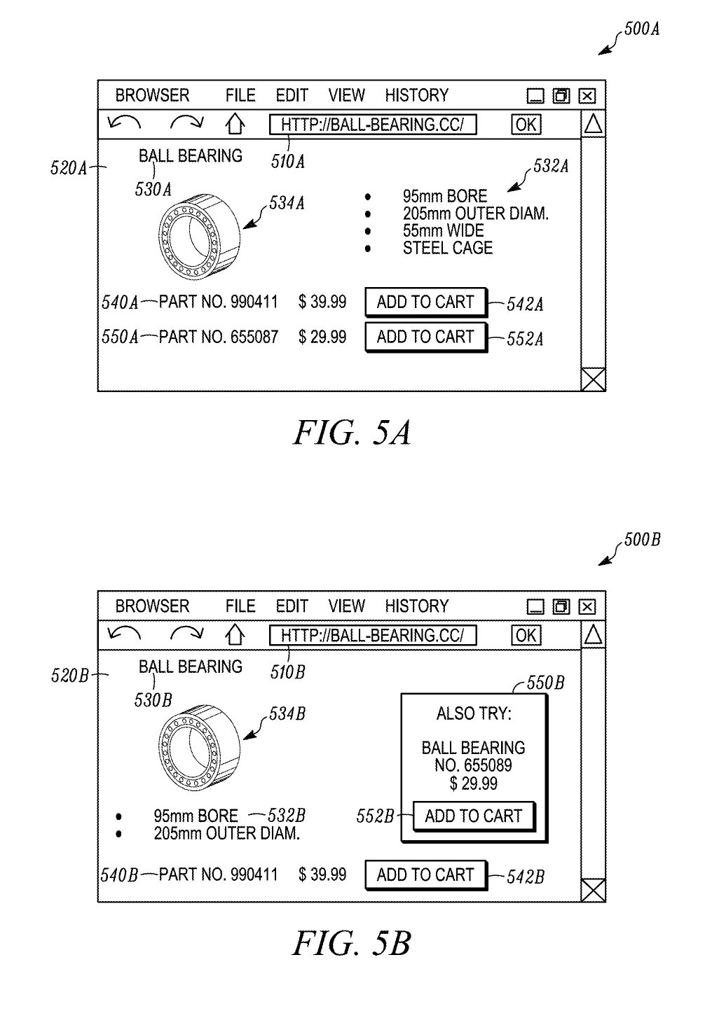

Referring to FIGS. 5A and 5B, two illustrative user interfaces 500A, 500B displaying item detail pages 520A, 520B are shown. In the item detail page 520A of FIG. 5A, item information 530A is shown, including item specifications 532A and an image 534A.

Additionally, the item detail page 520A identifies two distinct parts 540A, 5550A corresponding to the item information 530A, and includes features (e.g., a button) 542A, 552A for adding either of the parts 540A, 550A to a virtual shopping cart for an eventual purchase. In the item detail page 520B of FIG. 5B, item information 530B is shown, including item specifications 532B and an image 534B. The item detail page 520B identifies a part 540B corresponding to the item information 540B, and includes features (e.g., a button) 542B for adding the part 540B to a virtual shopping cart, and also a button or other selectable feature 552B for adding another part 550B to the virtual shopping cart.

As is discussed above, the item detail page 520A of FIG. 5A may be displayed when two or more parts are sufficiently interchangeable with or equivalent to one another. For example, where a confidence score or trust score of an equivalence of the two parts exceeds a predetermined threshold, the parts may be safely deemed equivalent to one another, such that the parts may be marketed together to customers on a common item detail page, such as the item detail page 520A of FIG. 5A. From the common item detail page 520A, a customer has the option of selecting either the part 540A or the 550A, which share the common specifications 532A. Likewise, the item detail page 520B of FIG. 5B may be displayed when two or more parts are believed to have at least some degree of interchangeability or equivalence. As is shown in FIG. 5B, the item detail page 520B associates the part 540B with the item specifications 532B and the image 534B, and includes a button 542B for adding the part 540A to a virtual shopping cart for eventual purchase. The item detail page 520B also displays the part 550B, but with an indirect association, or with an association less than the complete equivalence implied in the item detail page 520A of FIG. 5A.

Two or more items may be displayed in a manner that implies an interchangeability or equivalence thereof in a manner or to an extent consistent with the degree or level of confidence suggested by a confidence score or trust score. For example, where two items are deemed to be sufficiently interchangeable with or equivalent to one another, a set of results returned in response to a search for one of the items (e.g., a search for a particular spark plug by Brand A may return both the spark plug by Brand A and an equivalent spark plug by Brand B) may display both of the items, as well. Additionally, such search results may include an indicator of the confidence score or trust score (e.g., a numerical rating, a “star” rating, or a keyword or keywords) of the equivalence of each of items to a requested item. Likewise, the features of the item detail page 520A of FIG. 5A and the item detail page 520B of FIG. 5B may be combined. For example, two or more items that are sufficiently interchangeable with or equivalent to one another may be displayed as such, in the manner shown in FIG. 5A, and one or more other items that are also deemed to be interchangeable with or equivalent to one another, but to a lesser degree, may be displayed in a window or other form of separate area, in the manner shown in FIG. 5B. Any means or method for displaying items in a manner or to an extent consistent with their interchangeability with or equivalence to one another may be used in accordance with the systems and methods of the present disclosure.

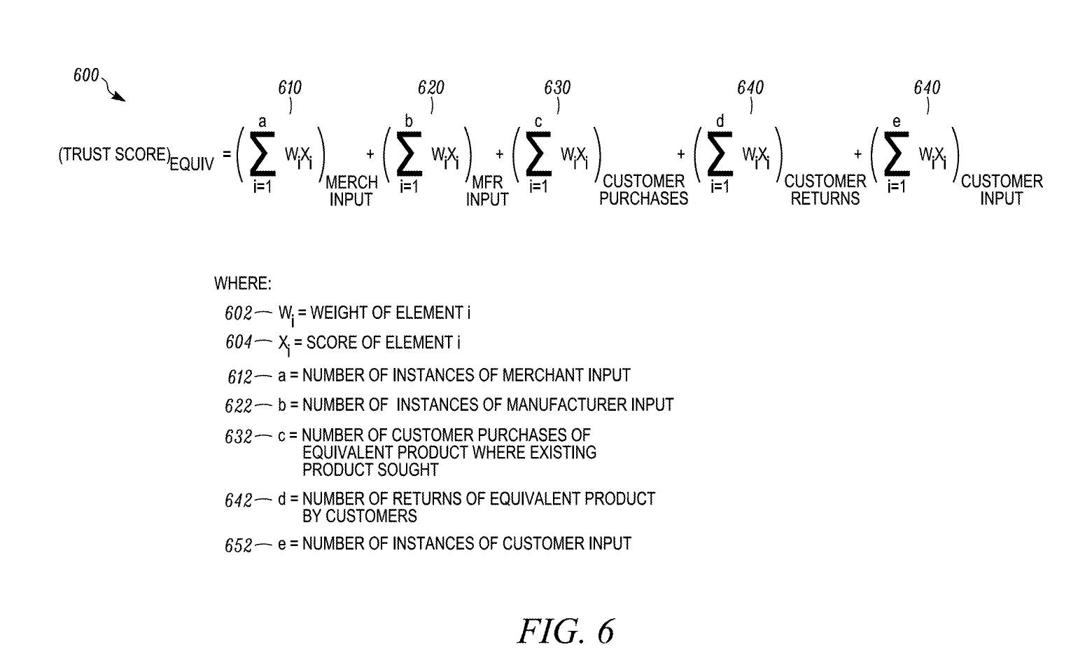

As is discussed above, a confidence score or trust score reflective of the interchangeability or equivalence of one or more items to one or more other items, or reflective of the reliability or accuracy of a source of information regarding such interchangeability or equivalence, may be calculated by or according to any known formulas, algorithms or other statistical means or methods. Referring to FIG. 6, a formula 600 for determining a trust score for a relationship between an item that has been offered as an equivalent (e.g., a newly offered item) with respect to an existing item in accordance with embodiments of the present disclosure is shown. The formula 600 of FIG. 6 is a weighted sum model that takes into account any number of inputs regarding an item and the interchangeability or equivalence of that item to an existing item.

As is shown in FIG. 6, the formula 600 may include components 610, 620 corresponding to instances of input provided by merchants and manufacturers, respectively, which may include any information, attributes, comments, feedback, assertions or statements of interchangeability or equivalence of the item to an existing item, or any actions that may be taken reflective of the interchangeability or equivalence of the items, by such merchants or manufacturers. Additionally, the formula 600 may further include a component 630 corresponding to purchases of the item by customers who originally sought the existing item, and a component 640 corresponding to returns of the item by such customers. The formula may also include a component 650 corresponding to instances of input provided by customers, including feedback, ratings, comments or any other expressions pertaining to the interchangeability or equivalence of the item to the existing item.

Each of the components 610, 620, 630, 640 of the formula 600 has a corresponding weight 602 for each element 604 associated with the respective component. The elements 604 refer to the input provided by merchants 612 and manufacturers 622 as to the interchangeability or equivalence of the item with the existing item, as well as customer purchases 632 and customer returns 642 of the item, and inputs 652 provided by customers regarding the interchangeability or equivalence of the item with the existing item. Any number of individual elements may be incorporated into the components 610, 620, 630, 640, 650 and may be summed according to the formula 600, according to the incidence or prevalence of such elements within a relationship of the items. For example, where the only source of functional attributes or functional information used in making a determination of interchangeability or equivalence of an item with one or more other items consists of assertions made by a merchant, the formula 600 will be driven exclusively by the value of the component 610.

The weights 602 of the elements in each of the components 610, 620, 630, 640, 650 may be selected on any basis, reflecting the significance of each component and its effect on the trust score. For example, an assertion of interchangeability or equivalence made by a merchant who is interested in marketing an item as an equivalent to another item may have a lower weight than such an assertion of interchangeability or equivalence made by a manufacturer of either item. Likewise, a purchase of an item by a customer, who may have the strongest interest in the accuracy or precision of a determination of interchangeability or equivalence may have a greater weight than any assertions of interchangeability or equivalence made by either merchants or manufacturers of items. Further, a return of a purchased item that was identified as an equivalent to another item may have an even greater weight than the purchase of the item itself, as such a return may correct any implication or understanding that may have been drawn based on the customer's purchase of the item with the belief that it was equivalent to the other item. Finally, customer comments or feedback as to the interchangeability or equivalence of the item to the other item may carry a greater weight than any particular component.

Moreover, the weights 602 or the elements 604 in the respective components 610, 620, 630, 640, 650 may have either negative or positive values, and a value of the trust score calculated according to the formula 600 may be driven accordingly. For example, those skilled in the pertinent art would recognize that a customer purchase of an item marketed as an equivalent to another item would have a positive impact on a trust score for that item (e.g., would increase the value of a trust score calculated according to a formula such as the formula 600) while a customer return of an item marketed as an equivalent to another item would have a negative impact on such a trust score. Likewise, where a manufacturer or customer makes a positive assertion of interchangeability or equivalence, the value a trust score may increase accordingly.

Any other factor or variable may be incorporated into one or more formulas, algorithms or models for determining whether items are interchangeable with or equivalent to one another, including but not limited to comments or feedback that may be identified as posted on one or more blogs or other sites of interest to those engaged in certain trades or groups. In addition to the weighted sum formula 600 of FIG. 6, any other formulas, algorithms or models may be used in accordance with the present disclosure, including weighted item models, artificial neural networks or other data analytic methods that identify one or more aspects of items that are essential to determinations of interchangeability or equivalence, and determine a confidence score or trust score based on such aspects.

Moreover, a trust score may be calculated and/or assigned to a source of functional attributes or functional information (e.g., a manufacturer or merchant who asserts the interchangeability or equivalence of one or more items with one or more other items) using one or more formulas, equations or models, including a formula similar to the formula 600 of FIG. 6. Whereas the formula 600 of FIG. 6 derives a trust score to be applied to an item based on functional attributes or functional information regarding the interchangeability or equivalence of the item to other items, a formula for calculating a trust score to be assigned to a source of such attributes or information may take into account the reliability of a source in asserting that two or more items are interchangeable with or equivalent to one another, and may also increase or decrease over time.

Although the disclosure has been described herein using exemplary techniques, components, and/or processes for implementing the present disclosure, it should be understood by those skilled in the art that other techniques, components, and/or processes or other combinations and sequences of the techniques, components, and/or processes described herein may be used or performed that achieve the same function(s) and/or result(s) described herein and which are included within the scope of the present disclosure.

For example, those skilled in the art would recognize that the systems and methods of the present disclosure may be adapted for use in applications other than an electronic marketplace, e.g., in connection with a blog or other web resource of interest to members of a certain trade or group). Additionally, although many of the embodiments described above relate to industrial parts such as ball bearings, those skilled in the art would also recognize that the systems and methods disclosed herein are not so limited, and may be utilized to identify interchangeable or equivalent parts or items in any field.

It should be understood that, unless otherwise explicitly or implicitly indicated herein, any of the features, characteristics, alternatives or modifications described regarding a particular embodiment herein may also be applied, used, or incorporated with any other embodiment described herein. Moreover, with respect to the one or more methods or processes of the present disclosure described herein, including but not limited to the flow charts shown in FIGS. 2 and 4, the order in which the boxes of the methods or processes are listed is not intended to be construed as a limitation on the claimed inventions, and any number of the method or process boxes can be combined in any order and/or in parallel to implement the methods or processes described herein. Also, the drawings herein are not drawn to scale.

Conditional language, such as, among others, “can,” “could,” “might,” or “may,” unless specifically stated otherwise, or otherwise understood within the context as used, is generally intended to convey that certain embodiments could include, but do not require, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Although the invention has been described and illustrated with respect to illustrative embodiments thereof, the foregoing and various other additions and omissions may be made therein and thereto without departing from the spirit and scope of the present disclosure.

1. (canceled)

2. A computer system configured to present, via a display associated with a computing device, multiple items based on confidence scores indicative of item equivalence, the computer system comprising:
one or more processors;
an electronic database that stores data regarding multiple items offered for sale via an electronic marketplace, wherein the data includes (1) functional attributes associated with at least first and second items, (2) confidence thresholds associated with the first item, (3) a first confidence score indicating a degree of equivalence between the first item and the second item that is based at least in part on a comparison of the functional attributes associated with the first and second items, and (4) a second confidence score indicating the degree of equivalence between the first item and the second item that is based at least in part on an identification, by a seller, of the second item as an equivalent with the first item; and
memory storing instructions that, when executed by the one or more processors, cause the computer system to at least:
receive, over a communications network from the computing device, at least one of an order for the first item or information regarding a return of the first item;
modify, by the one or more processors, the first confidence score that is based on the comparison of the functional attributes associated with the first and second items based at least in part on at least one of the order for the first item or the return of the first item;
modify, by the one or more processors, the second confidence score that is based on the identification, by the seller, of the second item as an equivalent with the first item based at least in part on at least one of the order for the first item or the return of the first item;
compare, by the one or more processors, the first and second confidence scores and the confidence thresholds associated with the first item; and
responsive to the first and second confidence scores meeting or exceeding a first confidence threshold of the confidence thresholds, cause the display associated with the computing device to present an item detail page comprising information regarding the first item and second item, wherein the item detail page is configured to present the first item and the second item in a same display format, and wherein the item detail page further comprises indications of the first and second confidence scores; and
responsive to the first and second confidence scores meeting or exceeding a second confidence threshold of the confidence thresholds and being below the first confidence threshold, cause the display associated with the computing device to present an item detail page comprising information regarding the first item and second item, wherein the item detail page is configured to present the first item in a first display format and the second item in a second display format that is different from the first display format, and wherein the item detail page further comprises indications of the first and second confidence scores.

3. The computer system of claim 2, wherein the memory storing instructions, when executed by the one or more processors, further cause the computer system to at least:
receive a request to offer the first item for sale at the electronic marketplace from the seller over the communications network, wherein the request comprises the functional attributes of the first item, and wherein at least one of the functional attributes of the first item is a first dimension of the first item;
receive the identification of the second item as an equivalent to the first item from the seller over the communications network, wherein the second item is offered for sale at the electronic marketplace;
identify the functional attributes of the second item, wherein at least one of the functional attributes of the second item is a second dimension of the second item;
calculate the first confidence score indicating the degree of equivalence between the first item and the second item based at least in part on a comparison of the first dimension of the first item with the second dimension of the second item; and
calculate the second confidence score indicating the degree of equivalence between the first item and the second item based at least in part on the identification of the second item as the equivalent to the first item received from the seller and the first confidence score.

4. The computer system of claim 2, wherein the same display format comprises the first display format; and
wherein the second display format comprises at least one of a separate window or a separate area presented within the item detail page.

5. The computer system of claim 2, wherein the indications of the first and second confidence scores comprise at least one of a numerical rating, a star rating, or a keyword.

6. A computer-implemented method comprising:
receiving, over a network, information regarding a first item to be offered for acquisition at an electronic marketplace from a source of the first item, wherein the information regarding the first item comprises a functional attribute of the first item;
identifying, using a computer processor, information regarding a second item offered for acquisition at the electronic marketplace, wherein the information regarding the second item comprises a functional attribute of the second item;
determining, using the computer processor, a degree of equivalence between the first item and the second item based at least in part on the information regarding the first item and the information regarding the second item, wherein determining the degree of equivalence comprises:
calculating, using the computer processor, a first confidence score indicative of the degree of equivalence;
receiving, over the network, at least one of an order for the first item or information regarding a return of the first item;
modifying, using the computer processor, the first confidence score based at least in part on at least one of the order for the first item or the return of the first item; and
comparing the first confidence score indicative of the degree of equivalence to a first confidence threshold and a second confidence threshold that is less than the first confidence threshold;
responsive to determining that the first confidence score meets or exceeds the first confidence threshold,
generating, using the computer processor, an item detail page comprising at least some of the information regarding at least one of the first item or the second item based at least in part on the degree of equivalence; and
causing, using the computer processor, a display of the item detail page on a computer display, wherein the item detail page presents the first item and the second item in a first display format; and
responsive to determining that the first confidence score meets or exceeds the second confidence threshold and is less than the first confidence threshold,
generating, using the computer processor, an item detail page comprising at least some of the information regarding at least one of the first item or the second item based at least in part on the degree of equivalence; and
causing, using the computer processor, a display of the item detail page on a computer display, wherein the item detail page presents the first item in the first display format and presents the second item in a second display format different from the first display format.

7. The computer-implemented method of claim 6, wherein responsive to determining that the first confidence score meets or exceeds the first confidence threshold,
the first item and the second item are presented via the item detail page in the first display format to indicate complete equivalence between the first item and the second item.

8. The computer-implemented method of claim 6, wherein responsive to determining that the first confidence score meets or exceeds the first confidence threshold,
the first item and the second item are presented via the item detail page in the first display format that is adjacent each other within the item detail page.

9. The computer-implemented method of claim 6, wherein responsive to determining that the first confidence score meets or exceeds the first confidence threshold,
causing, using the computer processor, the display of the item detail page on the computer display further comprises causing a display of the at least some of the information corresponding to the first item and the second item.

10. The computer-implemented method of claim 6, wherein responsive to determining that the first confidence score meets or exceeds the second confidence threshold and is less than the first confidence threshold,
the second item is presented via the item detail page in the second display format to indicate at least one of an indirect association or less than complete equivalence between the first item and the second item.

11. The computer-implemented method of claim 6, wherein responsive to determining that the first confidence score meets or exceeds the second confidence threshold and is less than the first confidence threshold,
the second item is presented via the item detail page in the second display format that comprises at least one of a separate window or a separate area presented within the item detail page.

12. The computer-implemented method of claim 6, wherein responsive to determining that the first confidence score meets or exceeds the second confidence threshold and is less than the first confidence threshold,
causing, using the computer processor, the display of the item detail page on the computer display further comprises causing a display of the at least some of the information corresponding to the first item.

13. The computer-implemented method of claim 6, wherein causing, using the computer processor, the display of the item detail page on the computer display further comprises causing display of an indication of the first confidence score.

14. The computer-implemented method of claim 13, wherein the indication of the first confidence score comprises at least one of a numerical rating, a star rating, or a keyword.

15. The computer-implemented method of claim 6, wherein causing, using the computer processor, the display of the item detail page on the computer display further comprises causing display of selectable features configured to receive selections of respective ones of the first item and the second item.

16. The computer-implemented method of claim 6, wherein calculating, using the computer processor, the first confidence score indicative of the degree of equivalence further comprises calculating the first confidence score based at least in part on the functional attribute of the first item and the functional attribute of the second item.

17. The computer-implemented method of claim 16, wherein the functional attribute of the first item comprises at least one of a dimension, a mass, a material, a use, a function, a country of origin, a color, or a capacity associated with the first item; and
wherein the functional attribute of the second item comprises at least one of a dimension, a mass, a material, a use, a function, a country of origin, a color, or a capacity associated with the second item.

18. A computer-implemented method comprising:
receiving, over a network, information regarding a first item to be offered for acquisition at an electronic marketplace from a source of the first item, wherein the information regarding the first item comprises a functional attribute of the first item;
identifying, using a computer processor, information regarding a second item offered for acquisition at the electronic marketplace, wherein the information regarding the second item comprises a functional attribute of the second item;
determining, using the computer processor, a degree of equivalence between the first item and the second item based at least in part on the information regarding the first item and the information regarding the second item, wherein determining the degree of equivalence comprises:
calculating, using the computer processor, a first confidence score indicative of the degree of equivalence;
calculating, using the computer processor, a second confidence score for the source of the first item indicative of the degree of equivalence, wherein the information regarding the first item identifies the second item as an equivalent of the first item;
receiving, over the network, at least one of an order for the first item or information regarding a return of the first item;
modifying, using the computer processor, at least one of the first confidence score or the second confidence score based at least in part on at least one of the order for the first item or the return of the first item; and
comparing at least one of the first confidence score or the second confidence score indicative of the degree of equivalence to a first confidence threshold and a second confidence threshold that is less than the first confidence threshold;
responsive to determining that the at least one of the first confidence score or the second confidence score meets or exceeds the first confidence threshold,
selecting at least some of the information regarding the first item or at least some of the information regarding the second item;
generating, using the computer processor, an item detail page comprising the selected at least some of the information regarding at least one of the first item or the second item based at least in part on the degree of equivalence; and
causing, using the computer processor, a display of the item detail page on a computer display, wherein the item detail page presents the first item and the second item in a same display format; and
responsive to determining that the at least one of the first confidence score or the second confidence score meets or exceeds the second confidence threshold and is less than the first confidence threshold,
selecting at least some of the information regarding the first item;
generating, using the computer processor, an item detail page comprising the selected at least some of the information regarding the first item based at least in part on the degree of equivalence; and
causing, using the computer processor, a display of the item detail page on a computer display, wherein the item detail page presents the first item in a first display format and presents the second item in a second display format different from the first display format.

19. The computer-implemented method of claim 18, wherein the first display format comprises presenting items adjacent one another within the item detail page;
wherein the same display format is the first display format; and
wherein the second display format comprises presenting items in at least one of a separate window or a separate area within the item detail page.

20. The computer-implemented method of claim 18, wherein causing, using the computer processor, the display of the item detail page on the computer display further comprises:
causing display of an indication of at least one of the first confidence score or the second confidence score;
wherein the indication includes at least one of a numerical rating, a star rating, or a keyword.

21. The computer-implemented method of claim 18, wherein causing, using the computer processor, the display of the item detail page on the computer display further comprises:
causing display of selectable features configured to receive selections of respective ones of the first item and the second item.
